(19) United States
(12) Patent Application Publication
(10) Pub. No.: US 2007/0262136 A1
(43) Pub. Date: Nov. 15, 2007

(54) Anti-Fraud Credit/Debit Card Authorization System and Method

(75) Inventor: Xiaofeng Ou, Great Falls, VA (US)

Correspondence Address: Xiaofeng Ou, 1011 Challedon Road, Great Falls, VA, 22066, US

(73) Assignee: Xiaofeng Ou, Great Falls, VA (US)

(21) Appl. No.: 11/307,311

(22) Filed: Jan. 31, 2006

(51) Int. Cl. G06K 5/00

(52) U.S. Cl. 235/380

(57) ABSTRACT

The invention provides a credit/debit authorization system and method which aim at stopping unauthorized use of credit/debit cards. The authorization system and method takes a two-step authorization approach. When a credit/debit card transaction authorization request is routed to the authorization system, the authorization system first validates the transaction by comparing card and transaction amount information extracted from the transaction to the account information stored in an account database. If the transaction is invalid, the authorization system refuses the transaction. If the transaction is valid, the authorization system then determines if the transaction requires the card user's approval. If it does, the authorization system would look up for user contact methods in a user contact database for that card with a pending transaction, establish a communication channel with the card user on his/her personal communication device, inform the user of a pending transaction with transaction related information, ask the user to take appropriate actions to either approve or refuse the transaction and process the user's response. If the user approves the transaction, the authorization system sends an approval code back to the device/system which started the transaction authorization request. If the user refuses the transaction, the authorization system sends a refusal code back to the device/system which started the transaction authorization request. In this way, unauthorized use of credit/debit cards can be stopped.

### FIELD OF INVENTION

The invention is related to a credit/debit card authorization system and method which aim at stopping unauthorized credit/debit card usage.

### BACKGROUND OF THE INVENTION

Credit and debit cards are widely used today. However information required for charge authorization is printed and stored on the cards themselves, such as card number, name and expiration date. When a card is lost, its information is potentially in danger. The same information is also presented at places where financial transactions take places. It means that many non-card users would gain access to it. Furthermore security compromise on the card issuer side could also leak credit/debit card information to undesired people. Because of the way that a credit/debit card transaction is authorized today, unauthorized use of credit/debit cards become a serious threat.

Prior arts have been invented to deal with credit/debit card security. U.S. Pat. No. 5,914,472 uses a smart card technology with one time random number for each transaction, but it requires a different type of credit card. U.S. Pat. No. 6,095,416 prevents a stolen/lost credit card from being misused, however it can not prevent unauthorized use by people who have access to credit card information via other legitimate methods, for example, by someone who has access to credit card purchase information because of his/her work. Furthermore it requires modifications of credit card itself. U.S. Pat. No. 6,636,833 uses a limited-use credit card which is associated with a master credit card. This method requires a user to download new limited-use card information each time a new transaction is required.

### REFERENCE

(1) U.S. Pat. No. 5,914,472
(2) U.S. Pat. No. 6,095,416
(3) U.S. Pat. No. 6,636,833

### SUMMARY OF THE INVENTION

The objective of this invention is to provide a credit/debit card authorization system and method which would deny unauthorized use of credit/debit cards without requiring any changes on credit/debit card itself.

In accordance with the present invention, a credit/debit card transaction system implements a two-step authorization approach which requires a card user's approval of a transaction on his/her card in addition to the normal credit/debit card transaction authorization. In this way, unauthorized use of credit/debit card can be stopped.

In step one, when a transaction is initiated on a credit/debit card, the transaction including card and charge amount information is routed to said authorization system. Said authorization system first validates the transaction by comparing card and transaction amount information extracted from the transaction to the account information stored in an account database. If extracted card information does not match what is stored in the account database and/or the transaction amount exceeds the card account spending limit, the transaction is deemed invalid, said authorization system refuses the transaction and sends a refusal code back to the transaction request initiator, where a transaction request initiator could be a card reader device used by a merchant or a financial system capable of initiating a transaction related to a credit/debit card.

In step two, if a transaction is deemed valid after it goes through step one, said authorization system then checks to see whether the transaction requires the card user's approval based on user contact criteria. If the transaction does not require the card user's approval, said authorization system accepts the transaction and sends an approval code back to the transaction request initiator.

If the transaction requires the card user's approval, said authorization system looks up for user contact methods in a user contact method database which holds information of user contact methods associated with credit/debit cards, starts a user contact method procedure by establishing a communication channel with the card user's personal communication device, posts transaction related information to the card user's personal communication device via voice or text messages, asks the card user to take appropriate actions to either approve or refuse the transaction, and processes the card user's response. A card user's personal communication device could be a cellular phone, two-way pager or other devices.

An example of a card user's action if the card user's personal communication device is a cellular phone is that after reviewing transaction related information from a voice announcement, he/she presses the “#” key on his/her cellular phone to approve a transaction or hits the “*” key to refuse a transaction.

If the card user approves the transaction, said authorization system sends an approval code back to the transaction request initiator. If the card user refuses the transaction, said authorization system sends a refusal code back to the transaction request initiator.

User contact criteria aforementioned are preconditions for a transaction when the card user's approval is required. User contact criteria are defined in such way which minimizes the impact of user approval procedure while maximizes the possibility of stopping fraudulent use of credit/debit card. It normally includes the following factors:
(1) when transaction amount is larger than a preset figure, and/or
(2) a transaction falls into particular category such as credit/debit card charge, and/or
(3) other policies which may include transaction request initiator identity.

A user contact method is an approach used by said authorization system to establish a communication channel between said authorization system and a card user on his/her communication device such as cellular phone, two-way paging device or other personal communication devices.

### BRIEF DESCRIPTION OF DRAWINGS

FIG. 1 is an illustration of said credit/debit transaction authorization system components, relationship among components and its interactions with transaction request initiators and card users.

(This drawing has been removed from this file. The drawing is now in a separate file called Fig1.pdf)

FIG. 2 shows credit/debit card transaction authorization steps and procedures.

(This drawing has been removed from this file. The drawing is now in a separate file called Fig2.pdf)

### DETAILED DESCRIPTION OF PREFERRED EMBODIMENT

The invention introduces a credit/debit card transaction authorization system and method which aims at stopping fraudulent use of credit/debit card information by requiring the card user's approval of transactions initiated on his/her card.

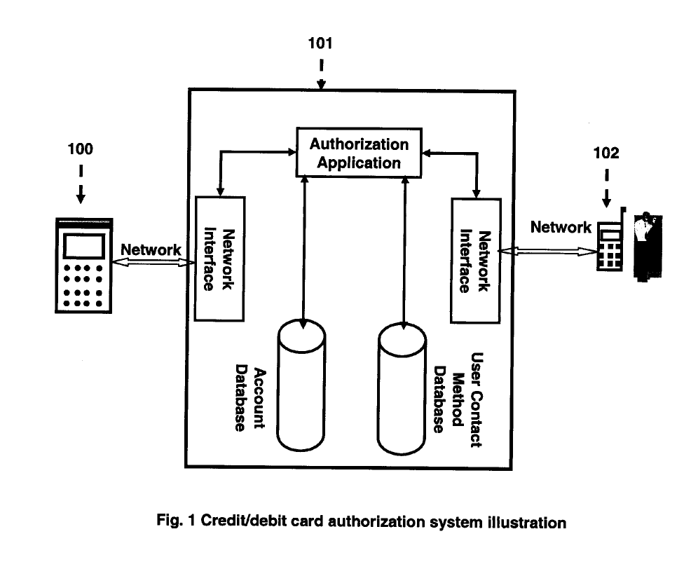

FIG. 1 is an illustration of the main functional components of said authorization system, relationship among components and relationship among transaction request initiator 100, said authorization system 101 and card user 102. The main functional components of said authorization system are inside the box of solid lines. Said authorization system has interface components to interact with transaction request initiators and card users. It has an authorization application to control every step of credit/debit card authorization procedures. The databases provide needed information for authorization purposes. All functional components of said authorization system maybe reside on a single system or on different systems connected with network.

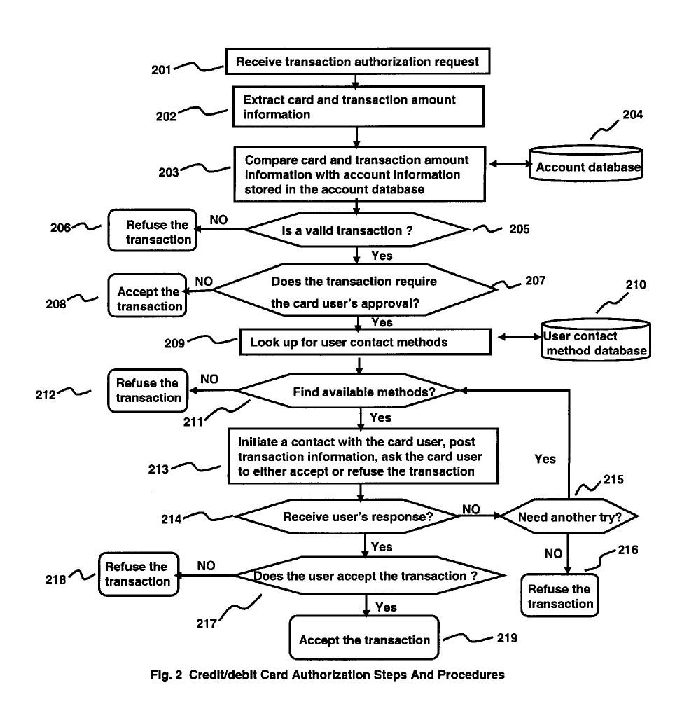

FIG. 2 shows the credit/debit card authorization steps and procedures implemented by said authorization system. When a credit/debit card transaction is initiated, which could be that a card is swiped at a card reader device or a financial system initiates a transaction request, the transaction is routed to said authorization system for processing at 201. Said authorization system extracts card and transaction amount information from the transaction at 202. Said authorization compares extracted card and transaction amount information with account information stored in 204 at step 203. At step 205, said authorization system determines whether the transaction is valid. If card information of the transaction does not match what is stored in the account database and/or the transaction amount is larger than the account spending limit, the transaction is deemed invalid, said authentication system refuses the transaction at step 206. If card information of the transaction matches what is stored in the account database and the transaction amount is less than the card account spending limit, the transaction is deemed valid. Said authorization system then determines whether the transaction requires the card user's approval at step 207 based on user contact criteria. If the transaction does not need the card user's approval, said authorization system accepts the transaction and sends an approval code back to the transaction request initiator at step 208.

If the transaction requires the card user's approval, said authorization system looks up in database 210 which holds user contact method information associated with credit/debit cards for user contact methods related to the card involved in the transaction at step 209. At step 211, said authorization system checks if user contact methods are available for the card. If no user contact method is available, said authorization system refuses the transaction and sends a refusal code back to the transaction request initiator at step 212. If user contact methods are available, said authorization system selects one method, initiates a communication channel with the card user, informs the user of a pending transaction on his/her card with transaction related information via voice or text messages and asks the user to take appropriate actions to either approve or refuse the transaction at step 213.

At step 214, if said authorization system does not receive a valid response from the card user within a preset time window, said authorization system determines at step 215 whether another user contact is required. If another user contact is required, said authorization system would try to find another user contact method and repeats step 211. If another user contact is not required, said authorization system refuses the transaction and sends a refusal code back to the transaction request initiator at step 216.

If at step 214, said authorization system receives a valid response from the card user within a preset time window, depending on the user's response, one of the following results:
a) if the user approves the transaction, said authorization system would send an approval code back to the transaction request initiator at step 219, or
b) if the user refuses the transaction, said authorization system would send a refusal code back to the transaction request initiator at step 218.

An example of the communication between said authorization system and a card user would be that said authorization system places a call to the card user's cellular phone, informs the user of a transaction on his/her card with a voice announcement which describes a charge of $150 from merchant ABC at 10:00 AM on Jan. 20, 2006 on a credit card with the last four digits of 6666, and asks the user to press the ‘#’ key to accept the transaction or press the ‘*’ key to refuse the transaction.

The invention is not limited to any particular user contact method other than the method should be private in its nature to a card user, and the card user and said authorization system can exchange information in a timely manner.

With the present invention, fraudulent use of credit/debit card cases would be greatly reduced if not totally eliminated. A counterfeit credit/debit card or stolen card information won't be able to complete a financial transaction without the card user's approval.

Although a preferred embodiment is shown and described, it is understood that many changes and modifications may be made therein without departing from the scope of the appended claims. For example, various user contact criteria can be defined on said authorization system, various mechanism can be implemented to handle the communication scenarios between said authorization system and card users.

What is claimed is:

1. An anti-fraud credit/debit card authorization system, comprising of the following:
a computer system having means of receiving credit/debit card transaction authorization request from transaction request initiators;
wherein transaction request initiators can be card reader devices used by merchants or financial systems capable of initiating transactions related to credit/debit cards;
a first account database having credit/debit card account information;
means of transaction authorization;
wherein transaction authorization is based on credit/debit card and transaction amount information;
a second user contact database having user contact methods associated with credit/debit cards;
means of executing user contact methods;
means of sending credit/debit transaction authorization code back to transaction request initiators.

2. An anti-fraud credit/debit card authorization system according to claim 1, wherein means of transaction authorization is to compare any of the following: card information, transaction amount extracted from a credit/debit transaction to the credit/debit account information stored in said first account database; and
a) if the card information of a transaction does not match what is stored in said first account database and/or the transaction amount exceeds the account spending limit, the transaction is deemed invalid, said computer system sends a refusal code back to the transaction request initiator, or
b) if the card information of a transaction matches what is stored in said first account database and the transaction amount is less than the account spending limit, the transaction is deemed valid, and
c) said computer system then checks if the transaction meets user contact criteria which are based on any of the following: transaction amount, transaction type, predetermined user contact policy, resulting in one of the following:
1) if the transaction does not meet user contact criteria, said computer system sends an approval code back to the transaction request initiator, or
2) if the transaction meets user contact criteria, said computer system starts a user contact method procedure.

3. An anti-fraud credit/debit card authorization system according to claim 2, wherein transaction type describes the function of a transaction, which could be credit/debit card charge, cash withdrawal, refund and any other legitimate business activities.

4. An anti-fraud credit/debit card authorization system according to claim 1, wherein user contact method is that said computer system establishes a communication channel with a card user's communication device including:
a. cellular phone;
b. two-way paging device;
c. personal communication devices which handle communications in a timely manner.

5. An anti-fraud credit/debit card authorization system according to claim 1, wherein means of executing user contact methods comprising of the following steps:
a) said computer system looks up in said second user contact database for user contact methods for a credit/debit card using credit/debit number as search key directly or indirectly;
b) said computer system establishes a communication channel with the personal communication device of a user whose card has a pending transaction;
c) said computer system informs the card user of a pending transaction on his/her card via voice or text messages with transaction related information including any of: transaction request initiator identity, transaction amount, transaction type, transaction location, transaction date/time, card information;
d) said computer system via voice or text messages asks the card user to take actions to either approve or refuse the transaction;
e) said computer system processes the user's response, and sends either an approval or refusal code back to the transaction request initiator accordingly.

6. An anti-fraud credit/debit card authorization system according to claim 5, wherein when said computer system processes user's response and sends either an approval or refusal code back to the transaction request initiator accordingly, said computer system performs one of the following:
1. if said computer system does not receive the card user's response in a preset time window, one of the following may occur:
1) said computer system sends a refusal code back to the transaction request initiator, or
2) said computer system looks up for alternate user contact method in said second user contact database and repeats user contact procedure if alternate user contact method is available, or
3) said computer system sends a refusal code back to the transaction request initiator if no alternate user contact method is available;
2. if said computer system receives the card user's response in a preset time window and the user approves the transaction, said computer system sends an approval code back to the transaction request initiator, or
3. if said computer system receives the user's response in a preset time window, and the user refuses the transaction, said computer system sends a refusal code back to the transaction request initiator.

7. An anti-fraud credit/debit card authorization system according to claim 1, wherein the first account database and second user contact database are either two separate databases or two components of a single database, and are accessible by said computer system.

8. An anti-fraud credit/debit card authorization method, comprising of the following steps
a) A computer system receives a credit/debit card transaction authorization request from a transaction request initiator;
b) said computer system compares any of the following: card information, transaction amount extracted from the credit/debit transaction to what is stored in a first credit/debit card account database which is accessible by said computer system;
c) if card information of the transaction does not match what is stored in said first account database and/or the transaction amount exceeds the account spending limit, the transaction is deemed invalid, said computer system sends a refusal code back to the transaction request initiator, or
d) if card information of the transaction matches what is stored in said first account database and the transaction amount is less than the account spending limit, the transaction is deemed valid, said computer system then checks if the transaction meets user contact criteria which are based on any of the following: transaction amount, transaction type, predefined user contact policies;
e) if the transaction does not meet user contact criteria, said computer system sends an approval code back to the transaction request initiator, or
f) if the transaction meets user contact criteria, said computer looks up for user contact methods for the credit/debit card involved in the transaction in a second user contact database which has user contact methods associated with credit/debit cards;
wherein credit/debit card number will be the search key in said second user contact database lookup directly or indirectly, and said second user contact database is accessible by said computer system;
g) said computer system starts a user contact method procedure, asks for the card user's concurrence on a pending transaction and processes the user's response;
h) if the transaction is refused by the card user, said computer system sends a refusal code back to the transaction request initiator, or
i) if the transaction is approved by the card user, said computer system sends an approval code back to the transaction request initiator.

9. An anti-fraud credit/debit card authorization method according to claim 8, wherein a transaction request initiator is a card reader device used by a merchant or a financial system capable of initiating a transaction related to a credit/debit card.

10. An anti-fraud credit/debit card authorization method according to claim 8, transaction type describes the function of a transaction, which could be credit/debit card charge, cash withdrawal, refund and any other legitimate business activities.

11. An anti-fraud credit/debit card authorization method according to claim 8, wherein user contact criteria are preconditions of starting user contact method procedures, which includes any of the following factors:
a. when the transaction amount of a transaction is larger than a preset amount, or
b. the transaction type of a transaction is credit/debit card charge, or
c. user contact polices set forth by card issuers.

12. An anti-fraud credit/debit card authorization method according to claim 8, wherein a user contact method is a call placed by said computer to a credit/debit card user's cellular phone.

13. An anti-fraud credit/debit card authorization method according to claim 8, wherein a user contact method is a communication initiated by said computer system with a card user's personal communication device.

14. An anti-fraud credit/debit card authorization method according to claim 8, wherein when said computer system starts a user contact method procedure, asks for the card user's concurrence on a pending transaction and processes user's response, said computer system performs the following:
a) establishes communication with the credit/debit card user's personal communication device;
b) via voice or text messages informs the user of a pending transaction on his/her card with transaction related information including any of: transaction request initiator identity, transaction amount, transaction type, transaction location, transaction date/time, card information;
c) asks the user to take appropriate actions either approving or refusing the transaction on his/her card;
d) processes the user's response, resulting in one of the following:
1) if said computer system does not receive the user's response in a preset time window, said computer system sends a refusal code back to the transaction request initiator, or said computer system looks up for alternative user contact method in said second user contact database and repeats user contact procedure if an alternate user contact method is available, or sends a refusal code back to the transaction request initiator if no alternate user contact method is available, or
2) if said computer system receives the card user's response in a preset time window and the user approves the transaction, said computer system sends an approval code back to the transaction request initiator, or
3) if said computer system receives the card user's response in a preset time window and the user refuses the transaction, said computer system sends a refusal code back to the transaction request initiator.

15. An anti-fraud credit/debit card authorization system, comprising of the following:
a computer system having means of receiving credit/debit card transaction authorization requests from transaction request initiators;
wherein transaction request initiators can be card reader devices used by merchants or financial systems capable of initiating transactions related to credit/debit cards;
a first account database having credit/debit card account information;
means of transaction authorization;
wherein transaction authorization is based on credit/debit card and transaction amount information;
a second user contact database having user contact methods associated with credit/debit cards;
means of executing user contact methods;
means of sending credit/debit transaction authorization code to a transaction request initiator.

16. An anti-fraud credit/debit card authorization system according to claim 15, wherein a user contact method is an approach used by said computer system to establish a communication channel with a credit/debit card user's communication device including cellular phone, two-way paging device and other personal communication devices.

17. An anti-fraud credit/debit card authorization system according to claim 15, wherein means of executing user contact methods is that when a credit/debit card transaction meets user contact criteria, said computer system establishes a communication channel with the card user's personal communication device, informs the user of a pending transaction on his/her card with transaction related information and asks the user to take appropriate actions to either approve or refuse the transaction; said computer system processes the user's response, and sends either an approval or refusal code back to the transaction request initiator based on the user's response accordingly.
